(19) United States
(12) Patent Application Publication
(10) Pub. No.: US 2017/0138912 A1
(43) Pub. Date: May 18, 2017

(54) Gas chromatograph and methods for using air as a carrier gas

(71) Applicants: Joseph John Zakzeski, Carson City, NV (US); Isa Alexandra Queiroz da Fonseca, Cacem (PT)

(72) Inventors: Joseph John Zakzeski, Carson City, NV (US); Isa Alexandra Queiroz da Fonseca, Cacem (PT)

(73) Assignee: Joseph John Zakzeski, Carson City, NV (US)

(21) Appl. No.: 14/940,151

(22) Filed: Nov. 13, 2015

(51) Int. Cl. G01N 30/30; G01N 30/66; G01N 30/86

(52) U.S. Cl. CPC G01N 30/30; G01N 30/8651; G01N 30/66; G01N 2030/3053

(57) ABSTRACT

The disclosure describes embodiments of an apparatus useful for the on-line analysis of gas and liquid samples including a gas compressor or pump, a sampling valve, a separation module, and one or more detectors. The detectors may include catalytic pellistors, thermal conductivity devices, or other sensors capable of detecting chemical substances in the presence of ambient air. These particular sensors in combination with reference elements allow direct use of ambient air as the carrier for analysis without pretreatment of the said air. Other embodiments are disclosed and claimed.

### TECHNOLOGICAL FIELD

The present disclosure relates to gas chromatography and in particular to gas chromatography independent of cylinder-contained carrier gas capable of automatic sampling of a flowing gas.

References Cited

| | | |
|---|---|---|
| U.S. Pat. No. 4,470,832 | Sep. 11, 1984 | Sugawara et al. |
| U.S. Pat. No. 4,814,612 | Mar. 21, 1989 | Vestal et al. |
| U.S. Pat. No. 4,883,504 | Nov. 28, 1989 | Gerstel |
| U.S. Pat. No. 5,340,543 | Aug. 23, 1994 | Annino et al. |
| U.S. Pat. No. 5,611,846 | Mar. 18, 1997 | Overton et al. |
| U.S. Pat. No. 5,922,106 | Jul. 13, 1999 | Mowry et al. |
| U.S. Pat. No. 6,627,454 | Sep. 30, 2003 | Amiravet al. |
| U.S. Pat. No. 6,293,995 | Sep. 25, 2001 | Wilson et al. |
| U.S. Pat. No. 7,194,890 | Mar. 27, 2007 | Tanaka et al. |
| U.S. Pat. No. 7,520,159 | Apr. 21, 2009 | Paakkanen et al. |
| U.S. Pat. No. 7,611,613 | Nov. 3, 2009 | Dutta et al. |
| U.S. Pat. No. 7,771,654 | Aug. 10, 2010 | Moore et al. |
| U.S. Pat. No. 7,827,849 | Nov. 9, 2010 | Nakashima et al. |
| U.S. Pat. No. 7,841,225 | Nov. 30, 2010 | Lehmann et al. |
| U.S. Pat. No. 8,017,405 | Sep. 13, 2011 | Jain et al. |
| U.S. Pat. No. 8,220,310 | Jul. 17, 2012 | Yamanak et al. |
| U.S. Pat. No. 8,303,694 | Nov. 6, 2012 | Tipler |
| U.S. Pat. No. 8,353,195 | Jan. 15, 2013 | Schmidt et al. |
| U.S. Pat. No. 8,431,889 | Apr. 30, 2013 | Zimmermann et al. |
| U.S. Pat. No. 8,562,837 | Oct. 22, 2013 | Tipler |
| U.S. Pat. No. 8,635,901 | Jan. 28, 2014 | Adkins et al. |
| U.S. Pat. No. 8,760,657 | Jun. 24, 2014 | Pope et al. |
| U.S. Pat. No. 8,857,241 | Oct. 14, 2014 | Nakashima |
| U.S. Pat. No. 8,904,859 | Dec. 9, 2014 | Lawrence et al. |
| U.S. Pat. No. 8,978,444 | Mar. 17, 2015 | Chou et al. |
| U.S. Pat. No. 9,173,607 | Nov. 3, 2015 | Boock et al. |
| U.S. Pat. No. 9,182,366 | Nov. 10, 2015 | Izawa et al. |

Foreign Patents

| | | |
|---|---|---|
| CN203798784 | Aug. 27, 2014 | Ma et al. |
| CN102778524 | Nov. 14, 2012 | Furukawa |

### BACKGROUND

Gas chromatography is an important means for detecting and identifying gas and liquid samples and determining concentration of a wide variety of substances in the chemical and biological industries. In the chemical industry, gas chromatography is used extensively to ensure product quality, such as during the production of fuels, plastics, and intermediates. In addition, gas chromatography can be used to detect volatile organic compounds present in wells or in refining bore holes. In other applications, gas chromatography can be used to determine the concentrations of dangerous substances, such as carbon monoxide or nitrogen-containing compounds, emitted from, for example, the exhaust system of an automobile.

Chromatography is a well-known method available to the analytical chemist for performing chemical separations and analysis. In particular, gas chromatography is the method of choice for separating volatile and gas phase samples. Typically, a gaseous sample is passed through a stationary phase which preferentially attracts selected compounds stronger than others, causing the differing compounds to elute through the stationary phase at different rates, thus causing separation. Under otherwise identical conditions, the retention time of a substrate is fixed and therefore can be used to identify compounds as they elute from the column. Considerable effort has been placed to increasing the separation efficiency of the compounds in order to reduce sampling time. For example, U.S. Pat. No. 7,520,159 to Paakkanen et al. disclose the use of a bundle of open tubular capillaries with a gas permeable wall comprising a polymer membrane, which enhances gas separation. The gas chromatogram contains detectors which convert a chemical state into an electrical signal, which may be further transmitted to a computer for analysis and processing. Examples of increasing the versatility of gas chromatograms include efforts disclosed in U.S. Pat. No. 5,340,543 to Annino et al, who describe the modular construction of a gas chromatogram to allow facile and rapid repairs to a unit.

Current gas analytical systems still rely on large, expensive laboratory equipment that is not easily transported due to their size and their reliance on having a steady delivery of high-purity carrier gas, often contained in gas cylinders. Indeed, current gas chromatography devices rely on the use of a carrier gas such as helium, hydrogen, argon, nitrogen, or other gas. These gases are usually ultra-high purity, expensive, and in the case of helium, in finite supply on earth. In some cases, the gas detectors, in particular flame ionization detectors also require pure and expensive gases, particularly hydrogen. Efforts to reduce the required detector gases include those disclosed in U.S. Pat. No. 6,627,454 to Amirav, wherein the gases required for the operation of the gas chromatograph system is produced in-situ by water electrolysis, either with or without separating the generated hydrogen from the generated oxygen. Often, the expense associated with continually supplying this carrier gas to an analytical device, in addition to the high cost of the analytical device itself, makes the widespread use of gas analytical systems, prohibitively expensive. Moreover, the requirement of using gas cylinders or other carrier gas sources requires the presence of significant infrastructure, which can be inconvenient when used in the field, which necessitates the inconvenient task of taking samples and storing them in containers, transporting the containers to the laboratory, and analyzing the samples often after considerable delay. This delay may also cause degradation of a sample, the analysis of which may then bring misleading results.

There have been efforts in chemical processing to provide improved gas separation and detection systems. A portable gas chromatography system that uses photoionization or flameionization detectors has been disclosed by U.S. Pat. No. 5,611,846 to Overton et al.. Methods have also been disclosed to reduce the quantity of cylinder gas required by, for example, recovering and recycling the used gas. For example, in the case where hydrogen is used as a carrier, U.S. Pat. No. 6,293,995 to Wilson discloses the use of a metal hydride storage system to recover and reuse the hydrogen carrier. A carrier gas recycling system was also disclosed in U.S. Pat. No. 6,074,461 by Wilson et al. U.S. Pat. No. 7,194,890 to Tanaka discloses the use of a gas chromatogram which uses a buffer tank provided upstream of the air pump to stabilize detector output in the presence of a negative temperature component thermistor for use as a breath analyzer. The buffer tank is necessary to pretreat the inlet air to remove miscellaneous impurities, which otherwise interfere with the detector baseline and precludes reliable analysis. Similarly, CN203798784 to Ma et al. discloses an air filter and gas storage tank for use in a transformer oil chromatographer.

There is a continuing need for a small, portable, inexpensive gas chromatograph with minimal operating costs both in terms of gas inputs, either for detectors or carrier gases, or energy. It is the purpose of this invention to provide a technology that avoids the use of expensive carrier and detector gases, increases portability and ease of use, and therefore makes the use of gas chromatographs more accessible for use in field applications, in research laboratories and relevant industrial processes, and for use in educational facilities.

### SUMMARY

The present invention relates to a gas chromatography apparatus for gas analysis in chemical applications. In a first aspect, a device for the measurement of a gas or liquid sample is provided, the device comprising: a gas compressor or pump mechanism configured to maintain a specific air pressure, a sampling valve through which a sample may flow and upon activation of the valve, introduce a volume of the sample into the air, an optional injection port, useful for injecting standard samples into the system for calibration or analysis purposes, a separation column used to separate the components of the sample, and one or more detectors capable of analyzing the separated components in the presence of air. At least one of these detectors contains a catalytic pellistor capable of selectively detecting combustible gas species without the need to pretreat the air carrier gas. One skilled in the art will recognize that the invention can be practiced without one or more of the specific details or with alternative configurations of controllers and components, which are nevertheless encompassed within the scope of the invention.

FIG. 1 illustrates an embodiment of a gas analysis device 100. Device 100 includes an air pump or air compressor 101, which is mounted in a support chassis 102. The signal from a pressure sensor 103 is used to determine the system pressure, which is adjusted to a predetermined level via a microcontroller 104 in connection with the air pump or air compressor 101. This pressure sensor may consist of a pressure transducer, a micro electric mechanical sensor, a strain sensor, or other pressure sensing devices known to those skilled in the art. The compressed air is transported via a tube network 105 to a sampling valve 106. The tube network may consist of plastic or metal tubing, including but not limited to stainless steel, Hasteloy, acrylic, Teflon, nylon, polyvinyl chloride, or other such tube materials known in the art.

A gas sample 107 may enter the sampling valve 106 from an inlet 108, pass through a sample loop 109, and exit the apparatus through a vent 110. FIG. 2 shows an exemplary configuration of the sampling valve in both the load and the inject position. In the load position, a gas or volatile liquid sample is introduced into a sample port and flows through a sample loop. The sample exits the valve through an exhaust vent. Upon activation, which changes the valve from the load position to the inject position, the sample 107 contained in a sample loop 109 will be introduced via an actuator 111 into the tube network pressurized by the air pump or air compressor 101. The sample loop 109 may be of any size with typical volumes ranging from 1 nL to more than 1 L of sample, with typical sizes of 1-100 μL. The size of the sample loop 109 may be predetermined prior to deployment and readily exchanged with larger or smaller sample loops and necessary to achieve acceptable sample detection. The valve may then be returned to the load position to prepare for introduction of a subsequent sample.

The sample may then be transported to an optional injection port 112, which may be used if desired to introduce samples via syringe for analysis or for the purpose of calibration. The sample port consists of a septum that causes a gas tight seal and an injection nut that keeps the septum in place. The sample port may be omitted from the device without limiting the utility of the sampling valve 106. The sample 107 is then transported to a separation module 113, which contains a packed or capillary column 114 for gas separation, and separates the sample 107 into its components. These columns may consist of fused silica capillary columns, metal capillary columns, packed and micropacked columns, plot columns, microfluidic devices, or other such devices known to those skilled in the art. The separation column is contained in a thermal chamber, 115, which contains heating elements 116 and temperature sensors 117 used to control the temperature of the column.

The separated components are then transported to a gas detection module 118. One or more gas detection sensors 119 and 120 may be contained in the gas detection module with sensors capable of detecting substrates in the presence of air. In the instance that only one sensor is used for gas detection, the sensor may consists of a sample destructive catalytic pellistor, which operates by burning the target gas and measuring the liberated heat relative to a parallel standard absent of the target gas, or a non-destructive sensor such as a thermal conductivity detector. Both detectors contain reference elements 121 to compensate for miscellaneous components in the carrier air, as described in more detail below. Through the use of this type of sensor, miscellaneous impurities found in the air do not influence the response, which results in a stable baseline. These sensors also compensate for changes in temperature or pressure in the carrier air.

In the case that multiple sensors are contained in the gas detection module 118, the first sensor 119 is preferably a non-destructive sensor, such as a thermal conductivity detector. The final sensor 120 in the gas detection module may be sample destructive. In a preferred embodiment, the destructive sensor consists of a catalytic pellistor, which is capable of detecting combustible gases. Additional sensors may include micro electro mechanical system sensors, infrared sensors, metal oxide sensors, or electrochemical sensors or other such sensors known in the art. Signals from the sensors are transmitted via a microcontroller 104 to a data recording and control system 122, which may consist of an internal or external computer. The data may be transmitted through any means known in the art, including but not limited to universal serial port cables or wireless communication 123.

FIG. 3 depicts the catalytic pellistor sensor, 120, which consists of a coil of a small diameter metal wire, preferably made from platinum supported on a refractory bead, in which a catalyst is deposited on the bead. A current is passed through the coil, which heats the bead up to an optimal temperature of approximately 500° C., at which point any combustible gas is burnt, producing heat. The resulting temperature rise is detected by the coil, in which the resistance rises, relative to an inactive reference bead, which adjusts for carrier composition, temperature, and pressure. The catalytic bead and the reference bead are most conveniently operated in a simple Wheatstone bridge circuit. This type of sensor is particularly advantageous as it does not require expensive hydrogen gas as a fuel source.

The thermal conductivity detector 119, may also comprise of two sensing mechanisms in which one mechanism is exposed to the target gas and the other mechanism, the compensator, is exposed only to carrier air at elevated temperatures, most preferably about 500° C. When the target gas has a thermal conductivity different than the carrier air, the rate of heat loss from the sensor will change relative to the compensator sensor. Thus, the thermal conductivity of the gas can be measured relative to the compensator. In the case that maintaining the consistency of the target gas is desired, such as useful in food or beverage applications where the olfactory characteristics of the target sample are to be determined, only non-destructive detectors such as the thermal conductivity sensor are used.

In the instance that combustible contaminants are present in the carrier air, the baseline offset caused by the contaminant is effectively eliminated by measuring the signal response from the sensor prior to injection of the target sample relative to the reference sensor. The resulting signal response caused by the contaminant can thus be adjusted from the target gas signal during measurement. Through the use of this technique in addition to the reference sensors, a stable baseline can be achieved.

After analysis through the sample system, the target gas can be vented through an outlet 124. In the case of food and beverage applications when non-destructive detectors are used, the target gas can be analyzed by an external olfactory detector, including the operator's nose.

The gas chromatograph may contain a display 125 including liquid crystal or video that outputs the results of the analysis, including sensor signals, temperature signals, pressure and flow parameters, and also indicate the status of the instrument.

Electricity is supplied to the components of the gas chromatogram via a power supply 126. The voltage delivered from the power supply may be adjusted to an optimal supply voltage of each subunit depending on the optimal operating voltage.

The microcontroller unit 104 has the logical functions of detecting the injection time and run time after injection of a sample either via the sample valve 106 or the injection port 112. Moreover, the microcontroller controls the power output to the heating chamber 115 based on feedback from a pressure sensor 117 and power to the pump 101 based on feedback from the pressure sensor 103. In addition, the microcontroller has an analyzing function of analyzing the signals received from the sensing device 118.

The concentrations of components detected by the sensor system can be determined via calibration curves as known to those skilled in the art. The addition of alternative analytical devices, such as infrared sensors, can be included to aid in product identification.

The heating chamber 115 may be optionally cooled by activation of a fan to flow cool ambient air through the chamber, thus reducing the cooling time between injections. Similarly, the entire chassis may be cooled via a separate fan 128, which may be activated if the internal temperature of the device becomes excessive.

### BRIEF DESCRIPTION OF DRAWINGS

FIG. 1. Is a schematic diagram showing the entire gas chromatograph system wherein gas tubing is depicted by solid lines and electrical connections are depicted by dashed lines.

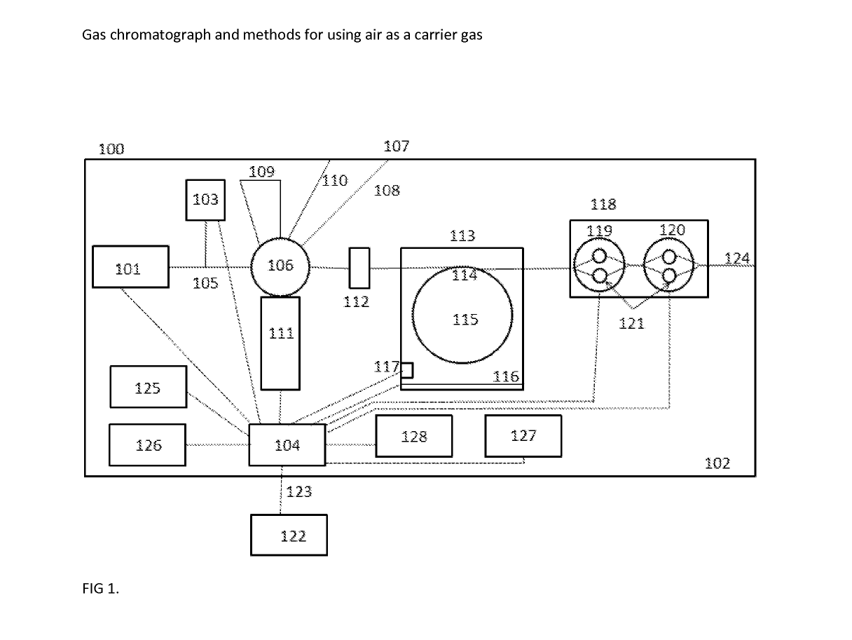

FIG. 2. Is a schematic of the injector valve in the load and inject positions

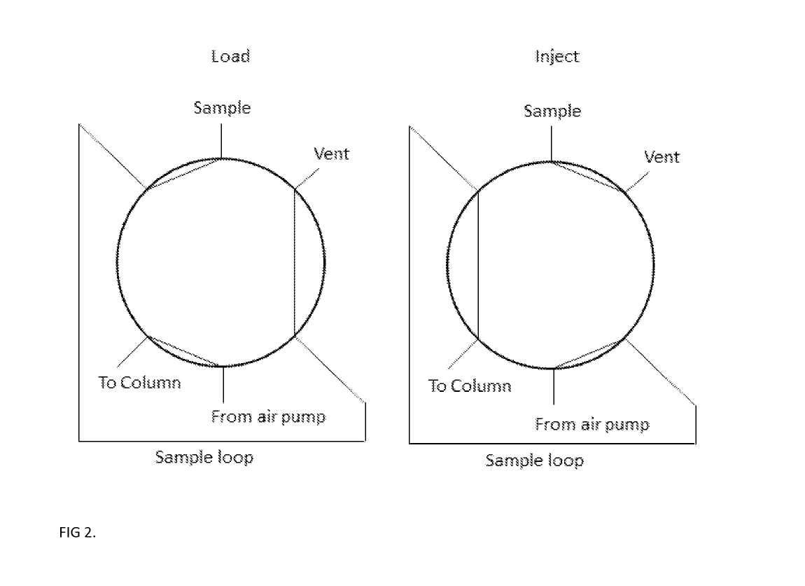

FIG. 3. Is a schematic diagram of the catalytic pellistor sensor with the active catalyst component and reference component used to correct for changes in air carrier temperature, pressure, and composition.

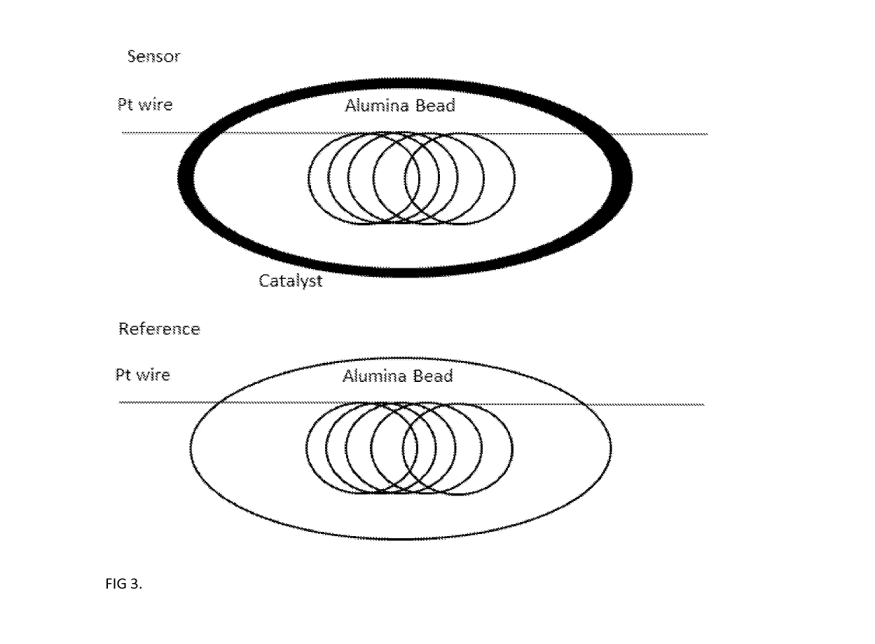

Gas chromatograph and methods for using air as a carrier gas

1. A gas chromatograph comprising: an inlet port for a sample gas; an air pump or air compression device for supplying air as a carrier gas into a sampling valve; a pressure or flow sensor useful for measuring flow of said carrier gas; an injection valve used to introduce a sample into a separation column; a gas separation column used to cause a flow delay depending on the gas component;
temperature sensors and heaters to control the separation column temperature; a gas sensor system capable of detecting the separated components emitted from the separation column; an outlet port for venting waste gas; a microcontroller to control the gas flow, temperature, and pressure, and to transmit signals from the sensors to a recording or analysis device.

2. The gas chromatograph of claim 1, in which the gas sensor system consists of a catalytic pellistor and reference, in which sample gas is combusted on the catalytic surface of the pellistor and the resulting temperature rise is detected by the rise in temperature and change in electrical resistance relative to a reference sensor where no combustion occurs.

3. The gas chromatograph of claim 1, in which the gas sensor system consists of a thermal conductivity detector and reference system in which the thermal conductivity detector is exposed to the target gas and the reference detector only to carrier air, and the change in the thermal conductivity detector and thus resistance relative to the reference sensor is used to detect the presence of gases.

4. The gas chromatograph of claim 1, in which the carrier gas is air compressed by means of an air pump or air compressor with pressure modulated from feedback from a pressure sensor.

5. The gas chromatograph of claim 1, in which the sampling valve is manipulated by an actuator that causes it to transition from a load to an inject position.

6. The gas chromatograph of claim 1, in which the separation column consists of fused silica, metal, packed columns, microfluidic devices, or plot columns.

7. The gas chromatograph of claim 1, in which the column temperature is modified via heating wire or resistance wire or via resistive heating in the case of metal columns, wherein the temperature is monitored by a temperature sensor.

8. The temperature sensor of claim 7, which may consist of resistive temperature detectors, thermistors, or thermocouples.

9. The gas chromatograph of claim 1, characterized in that said gas chromatograph is a portable device.

10. The gas chromatograph of claim 1, wherein the signal output from the device may be transmitted to a computer or recording device by cable or by wireless communication.
